(19) United States
(12) Patent Application Publication
(10) Pub. No.: US 2008/0306250 A1
(43) Pub. Date: Dec. 11, 2008

(54) RARE-EARTH AMIDATE CHELATES

(76) Inventor: DAMIEN F. REARDON, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/759,963

(22) Filed: Jun. 8, 2007

(51) Int. Cl. C01F 17/00

(52) U.S. Cl. 534/15

(57) ABSTRACT

The invention is directed to a composition having a lanthanide chelate being a lanthanide and a ligand wherein the ligand is represented by the formula

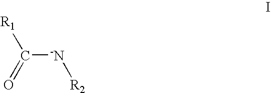

wherein R1 is alkyl, aryl, or heteroaryl; R₂ is alkyl, aminoalkyl, aryl or heteroaryl; with the proviso that R₁ and R₂ cannot both be phenyl, and with the proviso that R₂ cannot be phenyl when R₁ is alkyl.

### FIELD OF THE INVENTION

The present invention relates to chelates formed by complexation of rare-earth metals with amide ligands to form luminescent compositions. Uses include marking goods for purposes of identification.

### BACKGROUND OF THE INVENTION

A wide variety of luminescent rare-earth-containing compositions are known in the art. Ligated inorganic luminescent rare-earth-containing compositions supported by organic ultra-violet light absorbing ligands have been identified.

Rare-earth metal ions absorb ultraviolet light and luminesce in the visible or the infrared. When a rare-earth is complexed with certain organic ligands luminescence quantum yield of the rare-earth is enhanced by the broad band absorbance of the organic moiety in the ultraviolet spectrum which can efficiently transfer non-radiative energy to the emitting rare-earth ion.

Mathur et al., Synth. React. Inorg. Met.-Org. Chem. 11(3), 231-244 (1981) discloses lanthanide chelates wherein the associated ligands are represented by the formula R₁NHC(O)R₂ wherein R₁ is phenyl, chloro-phenyl, or nitro-phenyl, and R₂ is methyl or phenyl with the proviso that when R₂ is phenyl, R₁ is an unsubstituted phenyl. The lanthanide chelates disclosed therein were employed for infrared spectroscopic studies.

Many types of ligands are known in the art for use in forming chelates with rare-earth metals, and, even more generally, with transition metals. Despite this plethora of compositions, there is a continuing need for rare-earth chelates that luminesce with high quantum yield, particularly in the visible part of the light spectrum, and that exhibit thermal stability for processibility and extended use temperatures.

### SUMMARY OF THE INVENTION

The present invention provides a composition having a lanthanide chelate comprising a lanthanide and a ligand that together form a chelate structure, the ligand being represented by the formula

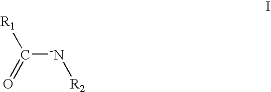

wherein R₁ is alkyl, aryl, or heteroaryl; R₂ is alkyl, aminoalkyl; aryl or heteroaryl with the proviso that R₁ and R₂ cannot both be phenyl and with the proviso that R₂ cannot be phenyl when R₁ is alkyl.

Further provided is a process which combines a solvent a saturated aliphatic lanthanide carboxylate or fluorocarboxylate having 1 to 8 carbons, and a supporting ligand represented by the formula

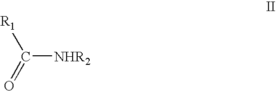

wherein R₁ is alkyl, aryl, or heteroaryl; R₂ is alkyl, aminoalkyl; aryl or heteroaryl with the proviso that R₁ and R₂ cannot both be phenyl and with the proviso that R₂ cannot be phenyl when R₁ is alkyl.

### BRIEF DESCRIPTION OF THE DRAWING

FIG. 1 illustrates the excitation and luminescence spectra of a product in powder form for corresponding Example 3.

### DETAILED DESCRIPTION

As described herein, the term “ligand” refers to an organic amide compound that can bond to a lanthanide metal by overlap of an empty orbital on the metal with a filled orbital on the ligand. The bonded anionic ligand is called the amidate. The “amide” is the neutral “protonated” ligand and the “amidate” is its “anionic” counterpart which has been deprotonated and bears a delocalized negative charge through its resonance structure, as indicated by the structures:

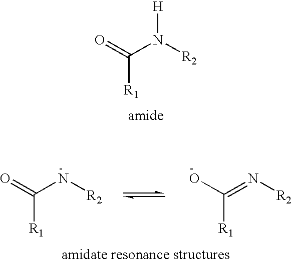

The term “chelate” means an inorganic complex formed between a lanthanide metal and a ligand that has a plurality of binding sites and wherein the ligand is bound to the metal at two or more of the binding sites of the ligand.

The present invention provides rare-earth amidate chelates that provide a desirable combination of luminescence and thermal stability. The compositions are useful for formulating coating compositions, including inks, paints, suitable for use in applying at least a partial coating on the surface of articles. Examples are cosmetic products, clothing, identification of genetic material (DNA), proteins, and product authentication. Because of their thermal stability, the compositions are well-suited for use in melt blending with polymers using conventional plastics processing methods, and forming into luminescent films or other shaped articles.

The structures represented by the formulae (I) and (II) are represented in the art to be resonant structures, as indicated by the following equilibrium reactions:

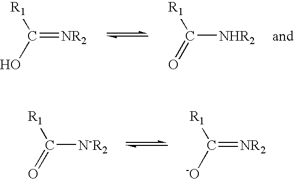

respectively. Formulae (I) and (II) will be employed to represent both resonant structures of each composition referred to.

The present invention lanthanide chelate comprising a lanthanide and a ligand that together form a chelate structure, the ligand being represented by the formula

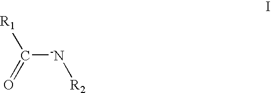

wherein R₁ is alkyl, aryl, or heteroaryl; R₂ is alkyl, aminoalkyl; aryl or heteroaryl, with the proviso that R₁ and R₂ cannot both be phenyl and with the further proviso that R₂ cannot be phenyl when R₁ is alkyl Any lanthanide except promethium and lutetium are satisfactory for use in the present invention. Preferred lanthanides are those that luminesce in the visible portion of the electromagnetic spectrum, including europium, dysprosium, samarium, terbium. Suitable lanthanides are in the +3 valence state. The lanthanide is selected from Eu³⁺, Dy³⁺, Tb³⁺, and Sm³⁺. Suitable aryls include but are not limited to phenyl, napthyl, anthracyl, or phenanthrenyl. Suitable heteroaryls include but are not limited to pyridinyl, quinolinyl, thionyl, furanyl, pyrollyl, oxazollyl, imidazollyl, pyrimidinyl, purinyl, nucleosides or keto tautomers of their enol forms. All aromatic compositions described herein may be substituted or unsubstituted. Examples of substituents include but are not limited to the radicals such as alkyl, aryl, halo, alkoxy, halogenated alkyl, sulfanyl, secondary amino, or nitro.

Suitable aminoalkyl groups are represented by the formula

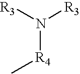

wherein each R₃ can independently be C1-C8 alkyl, preferably C1-C3, and R₄ can be C1-C8 alkenyl, preferably C2-C4. Most preferably, R₃ is methyl, and R₄ is ethenyl.

Ligands suitable for the composition include but are not limited to those represented by the formulae following, wherein Q can be O or S. Further, any six ring aryl structure can be replaced by a pyridinyl ring. Any of the aromatic rings can also have substituents including but not limited to alkyl, aryl, halo, alkoxy, halogenated alkyl, sulfanyl, secondary amino, or nitro.

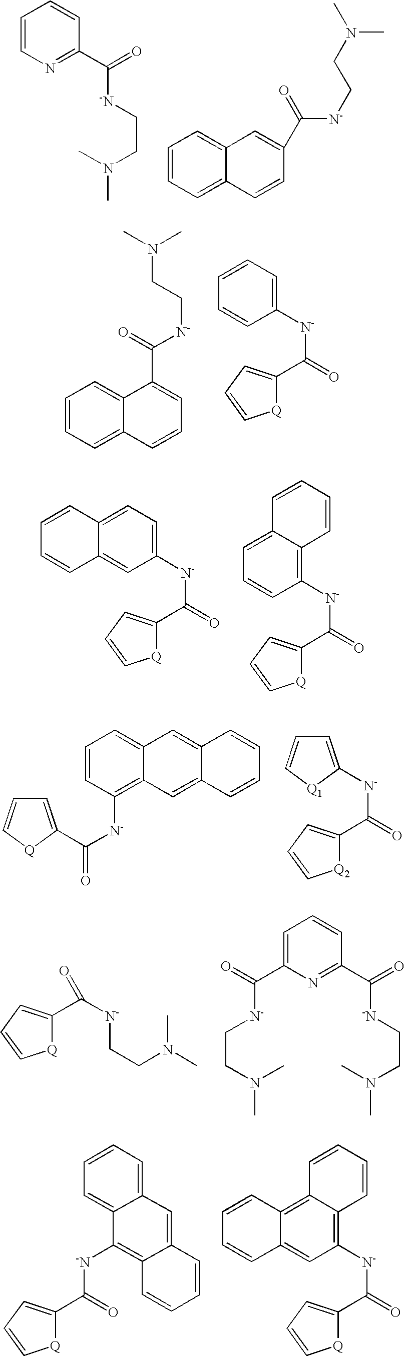

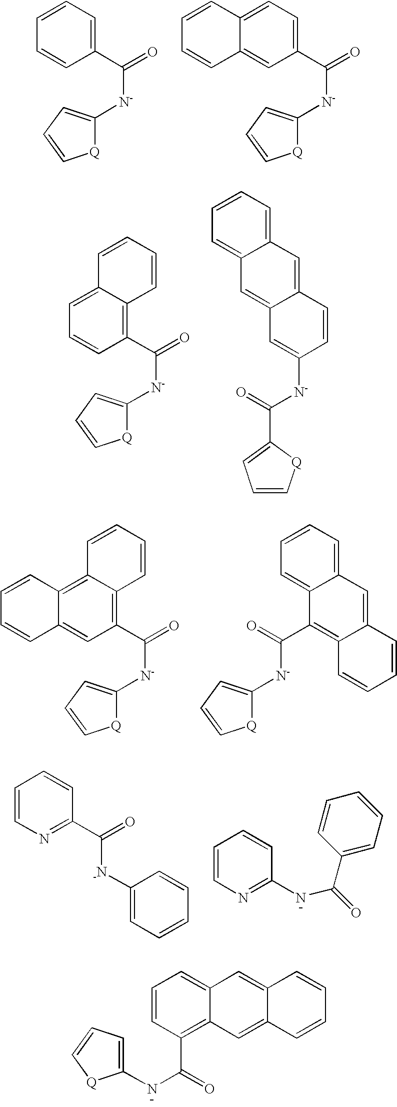

Also included are ligands having multiple heteroatoms in the aryl ring. For example pyrimidine, thiazole, oxazole, pyrrole, oxazole, imidazole, pyrimidine, purine, nucleosides or keto tautomers of their enol forms may be substituted for any of the aryl rings.

Embodiments of combinations of R₁ and R₂ in the anionic amidate ligand according to the present invention are recited in Table 1.

TABLE 1

| R₁ | R₂ |
|---|---|
| Heteroaryl ring | Aryl ring |
| Heteroaryl ring | Dialkylaminoalkyl group |
| Aryl ring | Dialkylaminoalkyl group |
| Aryl ring | Aryl ring |
| Aryl ring | Heteroaryl ring |

Preferably the heteroaryl ring is thiophenyl, pyridinyl or furanyl. Preferably the aryl ring is phenyl, naphthyl, anthracyl, or phenanthranyl. Preferably, the dialkylaminoalkyl group is dialkylaminoethyl. More preferably the dialkylaminoethyl is dimethylaminoethyl.

Also, included in the composition are lanthanide amidate complexes in combination with coordinating ligands including but not limited to heteroaryl rings, substituted or unsubstituted, such as pyridine, pyridine-N-oxide, thiophene, furane, ketones, 1,10-phenathroline, tri-substituted phosphine oxides and di-substituted ethylene bridged di-phosphine oxides. Suitable coordinating neutrally charged ligands are represented in the following structures:

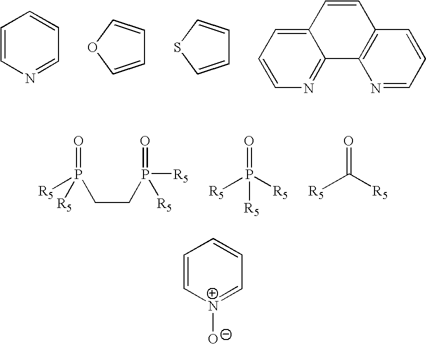

wherein each R₅ can independently be aryl or C1-C6 alkyl.

In the process of the invention, a saturated aliphatic lanthanide carboxylate or fluorocarboxylate having one to eight carbons, preferably one to six carbons, most preferably one to three carbons, is combined in a solvent with a compound represented by the formula

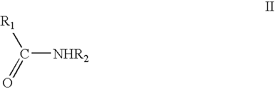

wherein R₁ is alkyl, aryl, or heteroaryl; and R₂ is alkyl, aminoalkyl; aryl or heteroaryl; with the proviso that R₁ and R₂ cannot both be phenyl and with the further proviso that R₂ cannot be phenyl when R₁ is alkyl. Typically, the ingredients are combined for a length of time necessary to achieve a desired amount of lanthanide amidate product (I).

Examples are lanthanide fluorocarboxylate and lanthanide trifluoroacetate. Any lanthanide except promethium and lutetium are satisfactory for use in the process. Examples are lanthanides that luminesce in the visible portion of the electromagnetic spectrum, including europium, dysprosium, samarium, and terbium. The lanthanides suitable for use in the process hereof are in the +3 valence states. Examples are Eu(CF₃COO)₃, Dy(CF₃COO)₃, Sm(CF₃COO)₃ and Tb(CF₃COO)₃. An alternate precursor route to synthesizing identical lanthanide chelate complexes described by structure in I can be achieved by combining an alkali metal salt of the ligand in its anionic form with a halogenated lanthanide precursor in an anhydrous solvent. Preferred alkali metals are Li⁺, Na⁺ and K⁺. Preferred halogenated lanthanide precursors bear F⁻, Cl⁻, Br⁻, or I⁻ halogens in their anionic form.

Such a synthetic route can be described by the following equation:

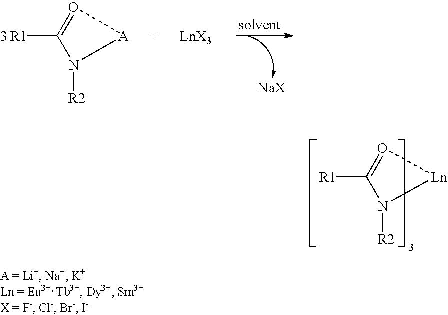

Suitable solvents are linear or cyclic alkanes, and aryl hydrocarbons, both halogenated and non-halogenated. A suitable example is dichloromethane.

Suitable aryls for use in R₁ or R₂ include but are not limited to phenyl, napthyl, anthracyl, or phenanthrenyl. Suitable heteroaryls include but are not limited to pyridinyl, quinolinyl, thionyl, furanyl, pyrollyl, oxazollyl, imidazollyl, pyrimidinyl, purinyl, nucleosides or keto tautomers of their enol forms. Suitable aryls or heteroaryls include substituted aryls or heteroaryls. Suitable substituents include but are not limited to the radicals such as alkyl, aryl, halo, alkoxy, halogenated alkyl, sulfanyl, secondary amino, or nitro.

Suitable aminoalkyl groups are represented by the formula

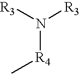

where each R₃ can independently be C1-C8 alkyl, preferably C1-C3, and R₄ can be C1-C8 alkenyl, preferably C2-C4. Most preferably, R₃ is methyl, and R₄ is ethenyl.

Suitable examples of compound (II) include but are not limited to compounds of the following formulae, wherein Q can be O or S. Further, any six ring aryl structure can be replaced by a pyridinyl ring. Any of the aromatic rings can also have substituents including but not limited to alkyl, aryl, halo, alkoxy, halogenated alkyl, sulfanyl, secondary amino, or nitro.

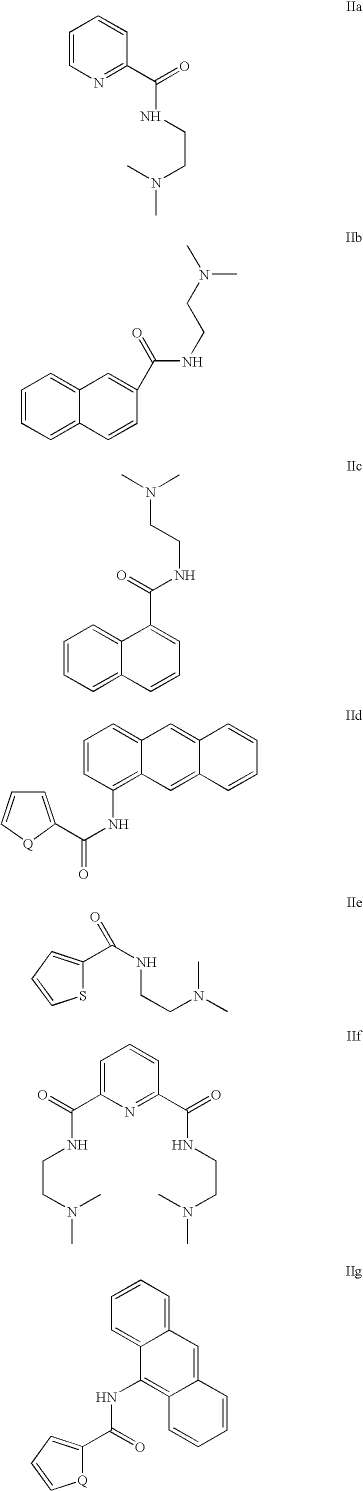

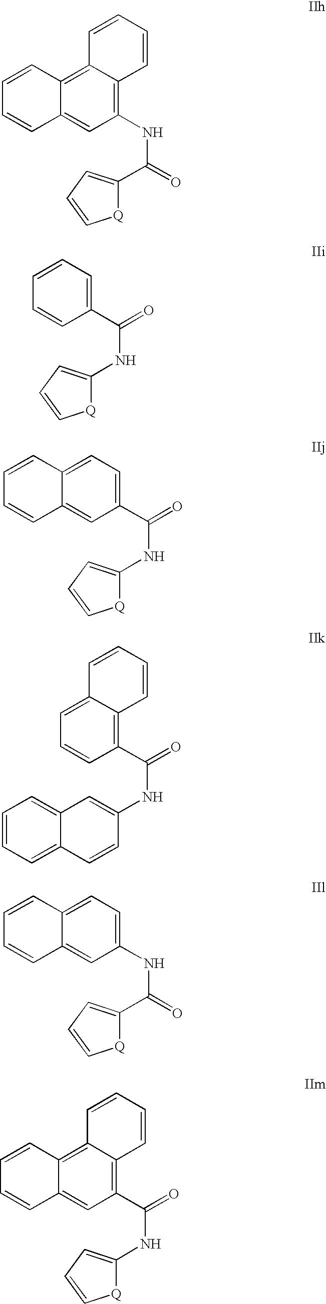

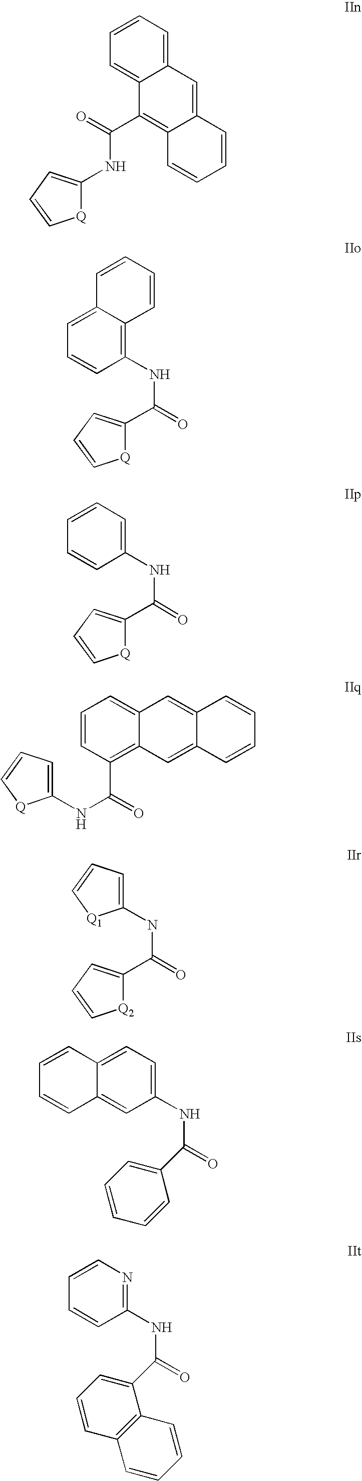

Also included are ligands having multiple heteroatoms in the aryl ring. For example pyrimidine, thiazole, oxazole, pyrrole, oxazole, imidazole, pyrimidine, purine, nucleosides or keto tautomers of their enol forms may be substituted for any of the aryl rings.

Embodiments of combinations of R₁ and R₂ in the anionic amide ligand according to the process are recited in Table 1, supra. Any of the aromatic rings in the compositions of Table 1 can also have substituents including but not limited to alkyl, aryl, halo, alkoxy, halogenated alkyl, sulfanyl, secondary amino, or nitro.

Preferably the heteroaryl ring is thiophenyl, pyridinyl or furanyl. Preferably the aryl ring is phenyl, naphthyl, anthracyl, phenanthranyl. Preferably, the dialkylaminoethyl group is dimethylaminoethenyl.

Suitable compounds (II) are known in the art, and can be prepared according to the methods of the art. For example, compound (III) where Q is sulfur can be prepared according to the method of Buu-Hoi et al., Recueil des Travaux Chimiques des Pays-Bas et de la Belgique (1949) 68, 5-33. Compound (IIs) can be prepared according to the method of Yabunouchi et al., WO2006073059. Compound (IIk) can be prepared according to the method of Beckmann et al., Berichte der Deutschen Chemischen Gesellschaft [Abteilung] B: (1923), 56B, 341-354. Compound (IIc) can be prepared according to the method of Giannini et al., Farmaco, Edizione Scientifica (1973), 28(6), 429-447. Compound (IIf) can be prepared according to the method of Davies et al., J. Organometallic Chem. (1998), 550(1-2), 29-57.

It has been found satisfactory in the process hereof to react the reactants at room temperature. However, it is anticipated that higher temperatures will accelerate the reaction. In general the maximum temperature of reaction will be limited by the boiling point of a suitable solvent. In general, it is found satisfactory to combine reactants at concentrations in a 3:1 mole ratio of the amide ligand to the lanthanide starting precursor with the exception of ligand IIF where the reaction occurred in a 2:1 mole ratio of amide ligand to the lanthanide precursor.

The product produced according to the process hereof is a tris-amidato lanthanide chelate as represented by the structure (III)

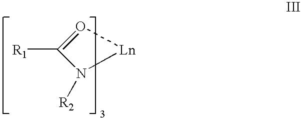

wherein Ln designates lanthanide, R₁ is alkyl, aryl, or heteroaryl; R₂ is alkyl, aminoalkyl, aryl or heteroaryl, with the proviso that R₁ and R₂ cannot both be phenyl and with the further proviso that R₂ cannot be phenyl when R₁ is alkyl.

In a further embodiment, the process according to the present invention may further comprise addition of a neutral coordinating ligand to a solution of the tris-amidato-lanthanide chelate (III) formed as described supra. Suitable coordinating ligands include but are not limited to heteroaryl rings such as pyridine, pyridine-N-oxide, thiophene, furane, ketones, 1,10-phenathroline, tri-substituted phosphine oxides and di-substituted ethylene bridged diphosphine oxides as represented in the following structures, which can have substituents including but not limited to including but not limited to alkyl, aryl, halo, alkoxy, halogenated alkyl, sulfanyl, secondary amino, or nitro:

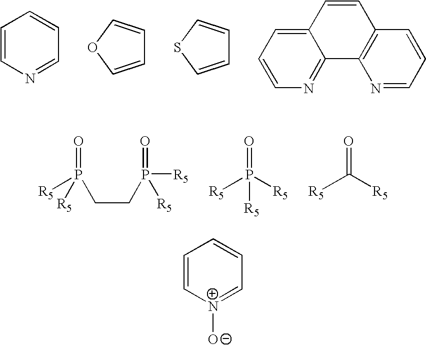

wherein each R₅ can independently be aryl or C1-C6 alkyl.

Coordination of these neutral ligands to the tris amidato lanthanide in the mole ratio range of 1:1 or 1:2 will yield the following representative structures:

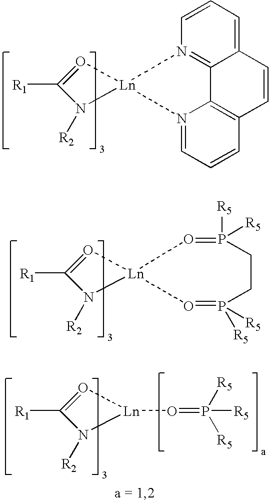

wherein R₁ is alkyl, aryl, or heteroaryl; R₂ is alkyl, aminoalkyl; aryl or heteroaryl, and each R₅ can independently be aryl or C1-C6 alkyl.

The rare-earth-chelates hereof can be combined with other ingredients to form compositions suitable for use as coatings or inks. In one embodiment, the rare-earth-chelate hereof is incorporated into an ink composition suitable for printing. In one embodiment the rare-earth-chelate hereof is placed into dichloromethane to form an ink suitable for printing. In another embodiment, the rare-earth-chelate hereof is incorporated into a paint composition to form a composition suitable for paints, which can be applied by any method known in the art including by brushing, rolling, or spraying.

Numerous chemical formulations are known in the art for preparing inks, paints, and other coating compositions. Any composition in the art that contains inorganic pigments in particulate form can be employed to formulate an ink, paint, or other coating composition with the rare-earth-chelate hereof serving as the pigment. The rare-earth-chelate hereof may serve as the only pigment, or it may be combined with other pigments and particulate matter such as is known to be suitable for use in the art of inks and coatings. In any case, the resulting coating formed therefrom is luminescent upon exposure to ultraviolet light that corresponds to an excitation wavelength of the specific composition.

The composition hereof is particularly useful for use in an ink-jet printing ink employed for marking articles, particularly manufactured goods subject to counterfeiting.

The invention hereof is further described in the following specific embodiments, but is not limited thereto.

### EXAMPLES

### Luminescence Spectra

The luminescence spectra in the examples below were determined using a Jobin-Yvon Spex Fluorolog spectrofluorometer. A 450 W Xe lamp was used as the excitation source. Gratings blazed at 330 nm with 1200 grooves/mm were used in the excitation monochromator. Gratings blazed at 500 nm with 1200 grooves/mm were used in the emission monochromator. A dry powder sample was loaded into a 15 mm long by 5 mm diameter quartz tube. The powder was tamped down to provide a smooth sample surface and the ends of the tube were sealed either with epoxy or cotton plugs. The sample tube was then loaded in a sample holder designed to hold these small tubes. Sample luminescence was measured from the front face of the tube, with an angle of 150 between the excitation and emission beams. A 400 nm low-pass filter was used to prevent the primary excitation beam in second or higher order of the emission monochromator from interfering with the results. Excitation and emission spectrometer bandwidths were 1 nm; spectrum step size was 1 nm; integration time was 0.1 second per data point. Data was corrected for the excitation Xe lamp intensity.

### Reagents

Except where noted, all reagents were supplied by EMD Chemicals, Inc.

### Example 1

### Ligand Synthesis

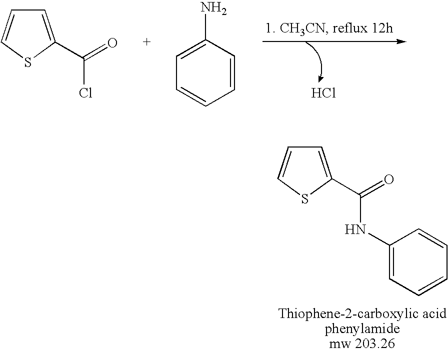

Under an atmosphere of argon gas, 5.31 ml of 2-thenoyl chloride (TCI America) was dissolved in 100 ml of anhydrous acetonitrile in a 250-ml round bottom Schlenk flask. To the solution so formed, 4.56 ml of aniline (99.5+% Aldrich) was added dropwise while stirring over a period of about 20 minutes. The reaction vessel was sealed with a stopper and the solution was stirred for 12 h at room temperature. The solution was then refluxed for 2 h at 82° C. in air. After refluxing, 100 ml of distilled water and 4 ml of ammonium hydroxide were added along with 100 ml diethyl ether in a separatory funnel. The phases were separated and the aqueous phase was washed with 100 ml of dichloromethane to capture any trace amounts of amide in the aqueous phase. The organic fractions were collected and dried with magnesium sulfate and the solvent was removed under reduced pressure to yield a white solid. Yield 77% (7.82 g; 38.5 mmol).

### Preparation of Anhydrous Eu(CF₃COO)₃

In a 250 ml round-bottom Schlenk flask, 25 g of europium (III) trifluoroacetate hydrate (Alfa Aesar) was heated under vacuum (30 mTorr) in a sand bath to 100° C. for a period of 12 h. The flask was back filled with Ar and was stored in an inert atmosphere until further use. The yield after dehydration was quantitative.

### Synthesis of Eu[C₁₁H₈NOS]₃

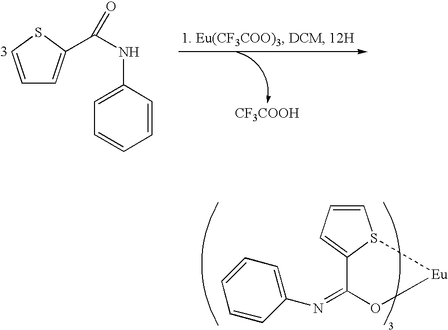

In 30 ml of anhydrous dichloromethane, 1.47 g of anhydrous europium(III) trifluoroacetate prepared supra was dissolved and 1.83 g of thiophene-2-carboxylic acid phenylamide was added. The solution so formed was stirred for 12 h after which the solvent was removed under reduced pressure to yield a white solid. The white solid was washed with three 10 ml aliquots of diethylether and was then dried under vacuum. Yield 68% (1.55 g; 758.68 g/mol).

Elemental Analysis [EuC₃₃H₂₄N₃O₃S₃]: calculated. (found) H, 3.18; (2.93), C, 52.24; (52.38), N, 5.54; (5.55).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

### Example 2

Thiophene-2-carboxylic Acid Phenyl Amide

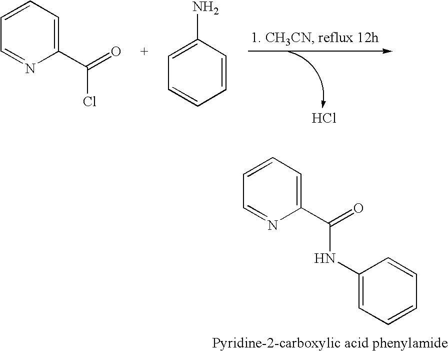

Under an atmosphere of argon gas, 0.2 ml of DMF and 2.72 ml of thionyl chloride (Fluka) were combined in 25 ml of anhydrous THF. The solution so formed was stirred for 5 minutes after which 3.07 g of 2-pyridine carboxylic acid was added and the resulting solution was then stirred for 12 h. After stirring, the solvent was removed under reduced pressure and the atmosphere back-filled with Ar. The white solid was dissolved in 100 ml of anhydrous acetonitrile and 2.28 ml of aniline (Sigma-Aldrich) was added dropwise over a period of about 20 minutes. The reaction was then refluxed for 2 h at 82° C. 100 ml of distilled water and 5 ml of concentrated ammonium hydroxide were then added along with 100 ml of diethylether in a separatory funnel. The phases were separated and the aqueous phase was washed with 100 ml of dichloromethane. The organic fractions were collected and dried with magnesium sulfate and the solvent was removed under reduced pressure to yield a white solid. Yield 84% (4.16 g; 21.0 mmol).

¹H NMR (CD₃OD): δ 8.63 (1H), 8.15 (1H), 7.93 (1H), 7.73 (2H), 7.51 (1H), 7.33 (3H), 7.12 (1H), 6.69 (1H)

¹³C NMR (CD₃OD): δ 164.31, 151.02, 150.78, 149.57, 139.03, 129.89, 127.87, 125.58, 123.32, 121.43, 119.20, 116.58.

Synthesis of Eu[C₁₂H₉N₂O]₃

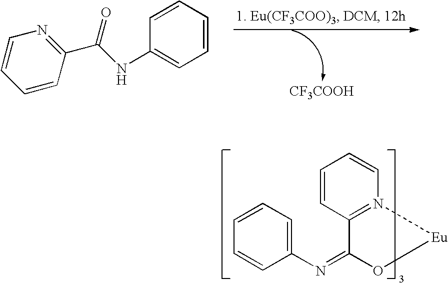

1.47 g of anhydrous europium (III) trifluoroacetate as prepared in Example 1 was dissolved in 30 ml of anhydrous dichloromethane, and treated with 1.78 g of pyridine-2-carboxylic acid phenylamide (9 mmol, 198.21 g/mol) as prepared supra. The solution was stirred for 12 h after which the solvent was removed under reduced pressure to yield a white solid. The white solid was washed with three 10 ml aliquots of anhydrous diethylether and was then dried under vacuum. Yield 71% (1.58 g; 743.57 g/mol).

Elemental Analysis [EuC₃₆H₂₇N₆O₃]: calculated. (found) H, 3.66; (3.92), C, 58.15; (57.99), N, 11.30; (11.27).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

### Example 3

### Amide Ligand Synthesis:

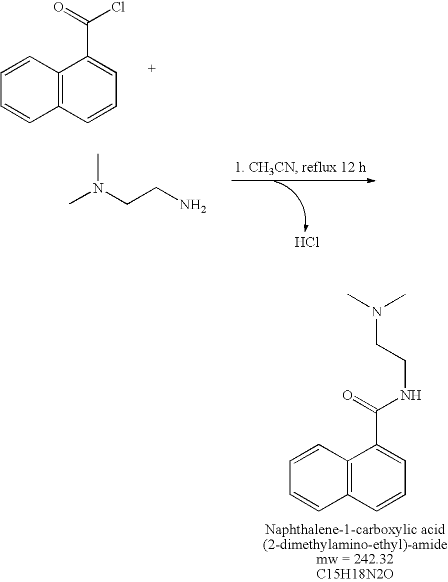

9.53 g of 1-Naphthyl carbonyl chloride (TCI America) was dissolved in 100 ml of anhydrous acetonitrile and subsequently, 5.51 ml of N,N-dimethylamino-ethane diamine (Sigma-Aldrich) was added dropwise. The reaction was stirred for 12 h and then refluxed for 2 h at 82° C. 100 ml of distilled water and 5 ml of concentrated ammonium hydroxide were added along with 100 ml of diethylether in a separatory funnel. The phases were separated and the aqueous phase was washed with 100 ml of dichloromethane. The organic fractions were then collected and dried with magnesium sulfate and the solvent was removed under reduced pressure to yield a white solid. Yield 10.63 g (43.87 mmol; 88%).

¹H NMR (CD₃CN): δ 8.29-8.27 (m, 1H), 7.93-7.88 (m, 2H), 7.56-7.50 (m, 3H), 7.47-7.44 (m, 1H), 7.03 (br, 1H), 3.46 (q, 2H), 2.46 (t, 2H), 2.21 (s, 6H)

¹³C NMR (CD₃CN): δ 169.89, 136.20, 134.66, 131.13, 130.95, 129.25, 127.74, 127.31, 126.54, 125.98, 125.93, 59.08, 45.75, 38.52

### Synthesis of Eu[C₁₅H₁₇N₂O]₃

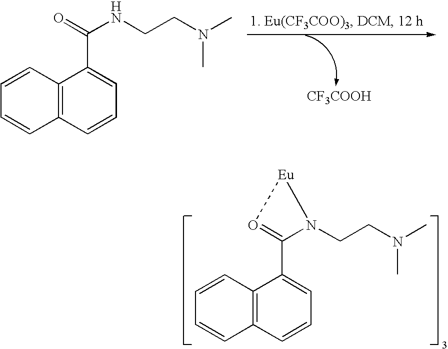

1.47 g (3 mmol, 490.99 g/mol) europium (III) trifluoroacetate of Example 1 and 2.18 g of naphthalene-1-carboxylic acid (2-dimethylamino-ethyl)-amide (9 mmol), as prepared supra, were combined in 42 ml of anhydrous dichloromethane. The solution so formed was stirred for 12 h upon which the solvent was removed under reduced pressure to yield a white solid. The white solid was washed with 3×10 ml aliquots of anhydrous diethylether and was then dried under vacuum. Yield 55% (1.44 g; 875.85 g/mol).

¹H NMR (CD₂Cl₂): δ 8.31 (br), 7.90 (d), 7.86 (d), 7.66 (m), 7.52 (m), 7.43 (m), 3.83 (br), 3.19 (br), 2.77 (s), 1.28 (m), 0.89 (t)

¹³C NMR (CD₂Cl₂): δ 134.09. 131.04, 130.59, 128.63, 127, 25, 126.66, 125.85, 125.15, 58.40, 44.54, 36.58, 32.25, 29.40, 23.06, 14.26.

Elemental Analysis [EuC₄₅H₅₁N₆O₃]: calculated. (found) H, 5.86; (5.97), C, 61.71; (60.46), N, 9.59; (9.40).

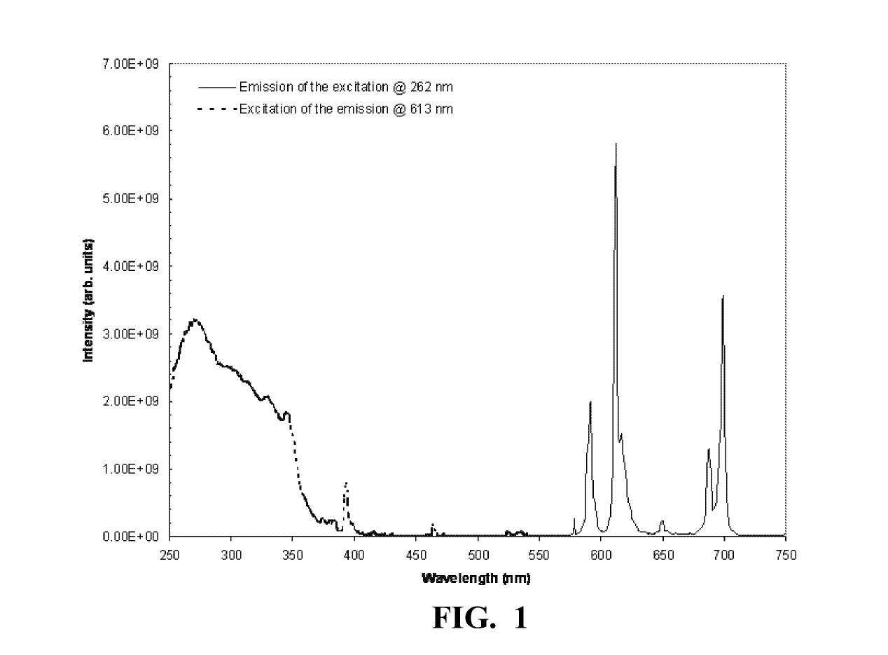

The excitation and luminescence spectra of the product in powder form is shown in FIG. 1.

### Example 4

### Ligand Synthesis

Pyridine-2-carboxylic acid (2-dimethylamino-ethyl)-amide

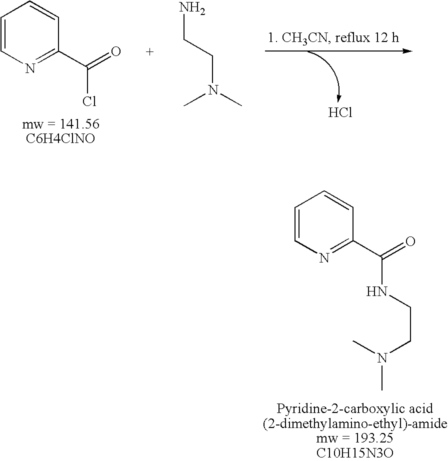

Under an atmosphere of argon gas, 0.2 ml of DMF, and 2.72 ml of thionyl chloride (Fluka) were combined in 25 ml of anhydrous THF. The solution so formed was stirred for 5 minutes after which 3.07 g of 2-pyridine carboxylic acid was added to the solution which was then stirred for 12 h. After stirring, the solvent was removed under reduced pressure and the atmosphere replaced with Ar. 100 ml of anhydrous acetonitrile was then added to dissolve the white solid and 2.74 ml of N,N-dimethylamino-ethane diamine (Sigma-Aldrich) was added dropwise to the solution over a period of ca 20 min. The reaction was then refluxed for 2 h at 82° C. 100 ml of distilled water and 5 ml of concentrated ammonium hydroxide were added along with 100 ml of diethylether in a separatory funnel. The phases were separated and the aqueous phase was washed with 100 ml of dichloromethane. The organic fractions were collected and dried with magnesium sulfate and the solvent was removed under reduced pressure to yield a white solid. Yield 94% (9.22 g; 47.72 mmol)

¹H NMR (CD₃CN): δ 8.57-8.55 (m, 1H), 8.26 (br, 1H), 8.08-8.06 (m, 1H). 7.91-7.87 (m 1H), 7.49-7.46 (m, 1H), 3.45 (q, 2H), 2.45 (t, 2H), 2.21 (s, 6H)

¹³C NMR (CD₃CN): δ 164.86, 151.24, 149.39, 138.57, 127.26, 122.69, 58.94, 45.56, 37.68.

### Synthesis of Eu[C₁₀H₁₄N₃O]₃

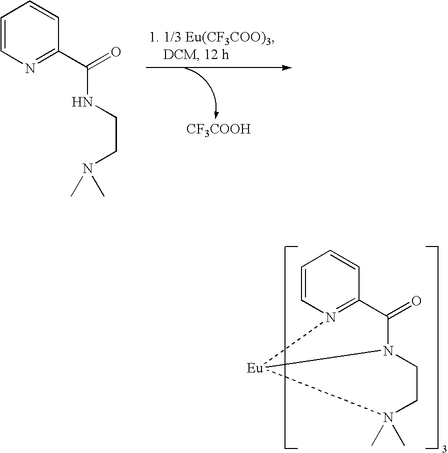

1.47 g of anhydrous europium (III) trifluoroacetate prepared as in Example 1 was combined with 1.74 g of pyridine-2-carboxylic acid (2-dimethylamino-ethyl)-amide In 50 ml of anhydrous dichloromethane. The solution was stirred for 12 h after which the solvent was removed under reduced pressure to yield a white solid. The white solid was washed with three 10 ml aliquots of anhydrous diethylether and 20 ml of anhydrous hexane. The white solid was then dried under vacuum. Yield 77% (1.68 g; 728.69 g/mol).

Elemental Analysis [EuC₃₀H₄₂N₉O₃]: calculated. (found) H, 5.81; (5.93), C, 49.45; (48.26), N, 17.30; (16.88).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

### Example 5

### Ligand Synthesis

Pyridine-2,6-dicarboxylic acid bis[(2-dimethylamino-ethyl)-amide

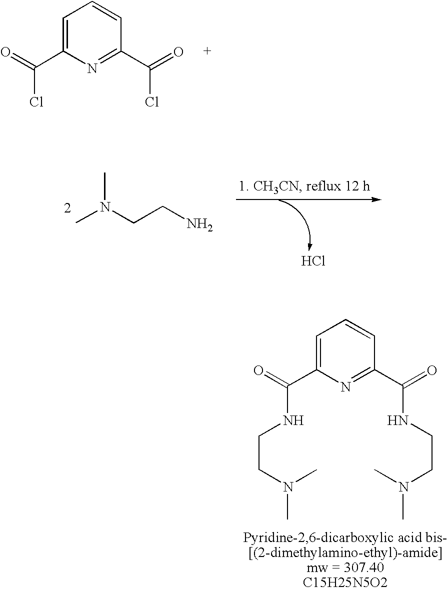

5.10 g of 2,6-pyridinedicarbonyl dichloride (Sigma-Aldrich) was dissolved in 100 ml of anhydrous acetonitrile. 5.50 ml of N,N-dimethylamino-ethane-diamine (Sigma-Aldrich) was added to the solution so formed in a dropwise fashion. The reaction mixture so prepared was stirred for 12 h and then refluxed for 2 h at 82° C. After refluxing, 100 ml of distilled water and 4 ml of concentrated ammonium hydroxide were added along with 100 ml of diethylether in a separatory funnel. The phases were separated and the aqueous phase was washed with 100 ml of dichloromethane. The organic fractions were collected and dried with magnesium sulfate and the solvent was removed under reduced pressure to yield a white solid. Yield: 5.53 g (17.99 mmol; 72%)

¹H NMR (CD₂Cl₂): δ 8.42 (br, 2H), 8.27 (d, 2H), 8.00 (t, 1H), 3.54 (q, 4H), 2.52 (t, 4H), 2.28 (s, 12H)

¹³C NMR (CD₂Cl₂): δ 163.82, 149.61, 139.12, 124.84, 58.84, 45.54, 37.45

### Synthesis of Eu[C₁₅H₅N₅O₂]₂

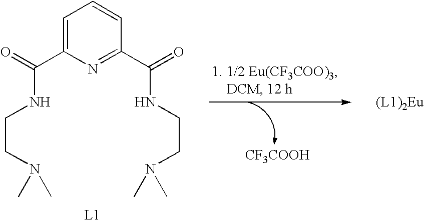

1.47 g of anhydrous europium (III) trifluoroacetate prepared as in Example 1 were combined with 1.84 g of pyridine-2,6-carboxylic acid bis[(2-dimethylamino-ethyl)-amide] in 40 ml of anhydrous dichloromethane. The solution so prepared was stirred for 48 h after which the solvent was removed under reduced pressure to yield a yellow oil. The oil was triturated with 20 ml of anhydrous diethylether and 10 ml of anhydrous hexane to yield a white solid. The white solid was then filtered and dried under vacuum. Yield 67% (1.53 g; 763.74 g/mol).

Elemental Analysis [EuC₃₀H₅₁N₁₀O₄]: calculated. (found) H, 6.70; (6.94), C, 46.93; (46.81), N, 18.24; (18.20).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

### Example 6

### Ligand Synthesis

Naphthalene-1-carboxylic Acid Phenylamide

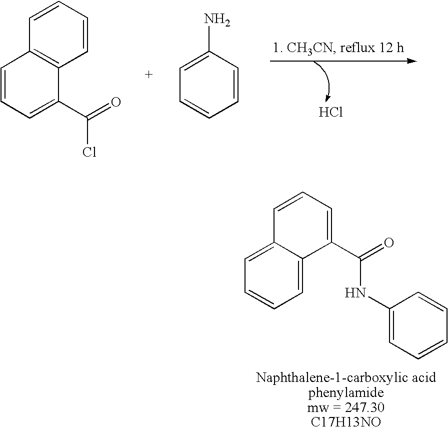

4.77 g of 1-naphthoyl chloride (TCI America) was dissolved in 100 ml of anhydrous acetonitrile. To the solution so formed, 2.28 ml of aniline (Sigma-Aldrich) was added in a dropwise fashion over a period of c.a. 20 min. The reaction was then refluxed for 2 h at 82° C. 100 ml of distilled water and 5 ml of concentrated ammonium hydroxide were added along with 100 ml of diethyl ether in a separatory funnel. The phases were separated and the aqueous phase was washed with 100 ml of dichloromethane. The organic fractions were collected and dried with magnesium sulfate, filtered and the solvent was then removed under reduced pressure to yield a white solid 5.07 g (82%; 20.5 mmol).

¹H NMR (CD₃CN): δ 8.81 (br, 1H), 8.30-8.28 (m, 1H), 8.01 (d, 1H), 7.97-7.95 (m, 1H), 7.77-7.72 (m, 4H), 7.58-7.54 (m, 4H), 7.40 (t, 2H), 7.16 (t, 1H)

¹³C NMR (CD₃CN): δ 168.58, 140.01, 135.68, 134.66, 131.44, 131.10, 129.83, 129.32, 128.05, 127.46, 126.47, 126.32, 125.93, 125.17, 121.18, 118.21

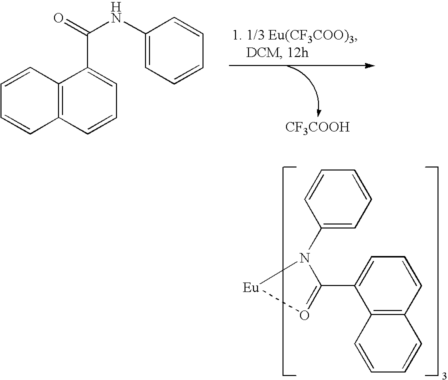

### Synthesis of Eu[C₁₇H₁₃NO]₃

1.47 g of anhydrous europium (III) trifluoroacetate prepared as in Example 1 was combined with 2.22 g of naphthalene-1-carboxylic acid phenylamide in 50 ml of anhydrous dichloromethane. The solution so formed was stirred for 24 h after which the solvent was removed under reduced pressure to yield a white precipitate. The white solid was washed with 20 ml of anhydrous diethyl ether and 10 ml of anhydrous hexane. The white solid was then filtered and dried under vacuum. Yield 64% (1.71 g; 890.84 g/mol).

Elemental Analysis [EuC₅₁H₃₉N₃O₃]: calculated. (found) H, 4.40; (4.61), C, 68.53; (68.37), N, 4.70; (4.69).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

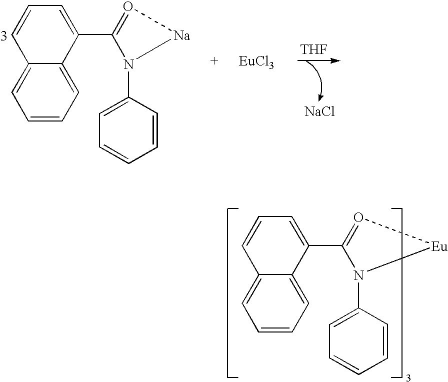

### Example 7

### Synthesis of Eu(C₁₇H₁₃NO)₃(C₁₂H₈N₂)

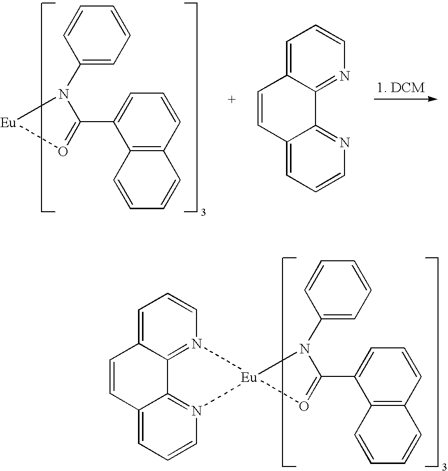

1.50 g of Eu(C₁₇H₁₃NO)₃ was combined with 0.30 g of 1,10-phenanthroline (Sigma-Aldrich) in 25 ml of anhydrous dichloromethane. Upon addition of the latter a white precipitate formed which was found to be insoluble in most common solvents. The white suspension was stirred for 12 h before the precipitate was filtered and washed with 10 ml aliquots of anhydrous dichloromethane and anhydrous tetrahydrofuran before drying the white solid under reduced pressure. Yield 1.32 g (73%).

Elemental Analysis [EuC₆₃H₄₇N₅O₃]: calculated (found) H, 4.41; (4.58), C, 70.45; (70.32), N, 6.52; (6.51).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

### Example 8

### Ligand Synthesis

Thiophene-2-carboxilic acid (2-dimethylamino-ethyl)amide

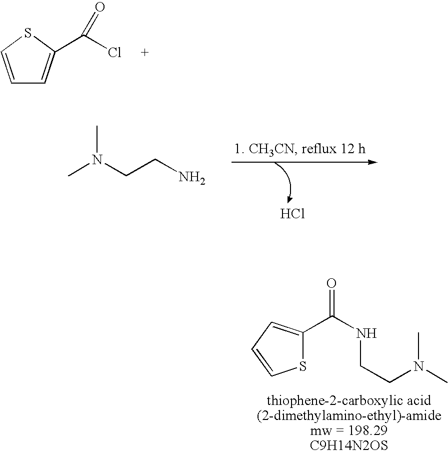

5.31 g of 2-thenoyl chloride (TCI America) was dissolved in 100 ml of anhydrous acetonitrile. 5.51 ml of N,N-dimethylamino-ethane diamine was added in dropwise to the solution so formed. The resulting reaction mixture was stirred for 12 h and then refluxed for 2 h at 82° C. 100 ml of distilled water and 5 ml of concentrated ammonium hydroxide were added along with 100 ml of diethylether in a separatory funnel. The phases were separated and the aqueous phase was washed with 100 ml of dichloromethane. The organic fractions were collected and dried with magnesium sulfate and the solvent was removed under reduced pressure to yield a white solid. Yield 82% (8.12 g; 41.00 mmol)

¹H NMR (CD₃CN): δ 7.56-7.54 (m, 2H), 7.09-7.07 (m, 2H), 3.39 (q, 2H), 2.43 (t, 2H), 2.19 (s 6H).

¹³C NMR (CD₃CN): δ 162.64, 140.97, 131.24, 128.80, 128.61, 59.16, 45.77, 38.47.

### Synthesis of Eu(C₉H₂N₂OS)₃

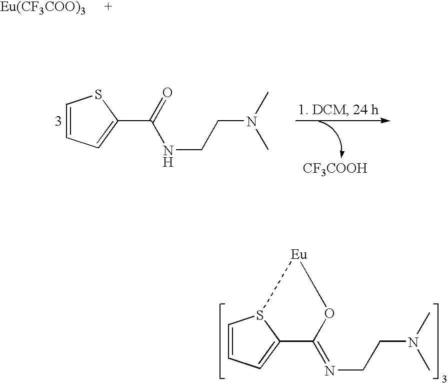

1.473 g of anhydrous europium(III) trifluoroacetate was dissolved in 50 ml of anhydrous dichloromethane. To the solution so formed, 1.785 g of thiophene-2-carboxylic acid (2-dimethylamino-ethyl)-amide was added and the resulting solution was stirred for 24 h. The solvent was removed under reduced pressure and the white solid was washed with anhydrous hexane. The white precipitate was dried to yield 1.84 g (69%; 746.77 g/mol) of final product.

¹H NMR (CD₂Cl₂): δ 7.54 (m, 1H), 7.49 (m, 1H), 7.08 (m, 1H), 3.54 (q, 2H), 2.68 (t, 2H), 2.41 (s, 6H)

¹³C NMR (CD₂Cl₂): δ 162.2, 130.16, 128.17, 127.99, 58.30, 45.02, 36.88.

Elemental Analysis [EuC₂₇H₃₆N₆O₃S₃]: calculated. (found) H, 4.89; (4.79), C, 43.77; (42.85), N, 11.34; (11.11).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

### Example 9

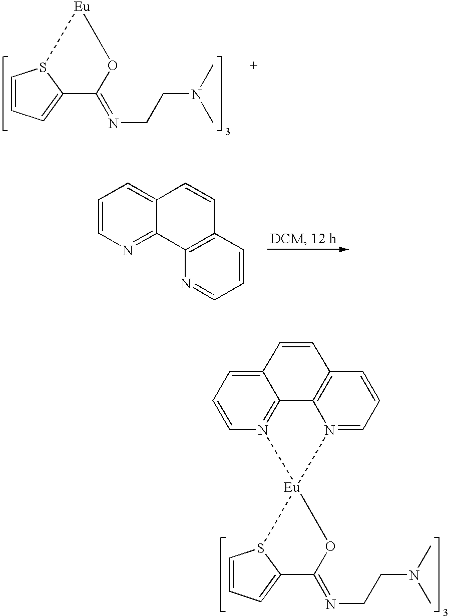

### Synthesis of Eu(C₉H₁₂N₂OS)₃(C₁₂H₈N₂)

1.50 g of the Eu[C₉H₁₃N₂OS]₃ of Example 9 and 0.55 g of 1,10-phenanthroline were dissolved in 25 ml of anhydrous dichloromethane. Upon addition of the latter a white precipitate formed which was found to be insoluble in most common solvents. The white suspension was stirred for 12 h before the precipitate was filtered and washed with anhydrous dichloromethane and anhydrous tetrahydrofuran before drying the white solid under reduced pressure. Yield 1.80 g (88%).

Elemental Analysis [EuC₃₉H₄₄N₂O₃S₃]: calculated. (found) H, 5.30; (5.41), C, 55.97; (55.90), N, 3.35; (3.34).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

### Example 10

### Synthesis of Eu(C₉H₁₂N₂OS)₃[OP(C₆H₅)₃]₂

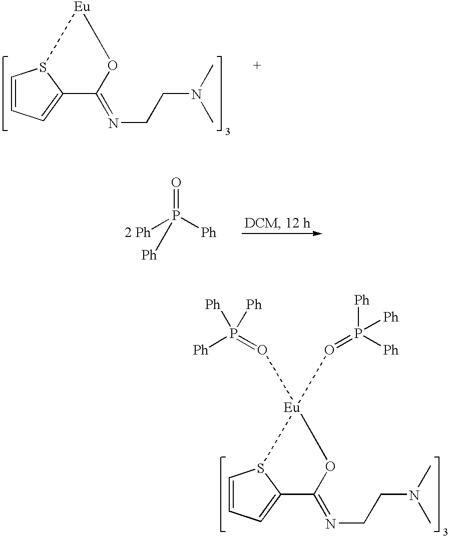

2.24 g (3.0 mmol; 746.77 g/mol) of the Eu[C9H13N2OS]3 of Example 9 was combined with 1.67 g of triphenylphosphine oxide in 25 ml of anhydrous dichloromethane. The solution so formed turned to a clear slightly yellow color upon addition of the triphenylphosphine oxide. The solution was stirred at room temperature for 12 h before removing the solvent under reduced pressure at which point a waxy oil was obtained. The residue was washed with anhydrous hexane and dried under vacuum. Yield 2.85 g (73%).

¹H NMR (CD₂Cl₂): δ 7.62, 7.52, 7.48, 7.44, 7.07, 3.68, 3.64, 2.87, 2.54, 1.81

¹³C NMR (CD₂Cl₂): δ 139.85, 132.24, 130.34, 128.90, 128.60, 128.04, 68.15, 58.38, 44.84, 25.93.

³¹P NMR (CD₂Cl₂): δ 27.71

Elemental Analysis [EuC₆₃H₆₆N₆O₅S₃P₂]: calculated. (found) H, 5.13; (5.06), C, 58.32; (57.61), N, 6.48; (6.40).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

### Example 11

### Synthesis of Tb(C₉H₁₂N₂OS)₃

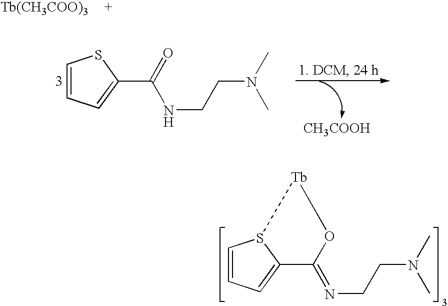

1.01 g of anhydrous terbium(III) acetate, purchased commercially and dehydrated in the manner of the europium fluoroacetate of Example 1, was dissolved in 50 ml of anhydrous dichloromethane. To this solution, 1.785 g of the thiophene-2-carboxylic acid (2-dimethylamino-ethyl)-amide of Example 9 was added and stirred for 24 h. The solvent was removed under reduced pressure and the white solid was washed with anhydrous hexane. The white precipitate was dried to yield 1.78 g (79%; 750.71 g/mol) of final product.

¹H NMR (CD₂Cl₂): δ 7.54 (m, 1H), 7.49 (m, 1H), 7.08 (m, 1H), 3.54 (q, 2H), 2.68 (t, 2H), 2.41 (s, 6H)

¹³C NMR (CD₂Cl₂): δ 162.2, 130.16, 128.17, 127.99, 58.30, 45.02, 36.88.

Elemental Analysis [TbC₂₇H₃₆N₆O₃S₃]: calculated. (found) H, 4.85; (5.00), C, 43.37; (42.34), N, 11.34; (10.97).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

### Example 12

### Synthesis of Dy(C₁₁H₈NOS)₃

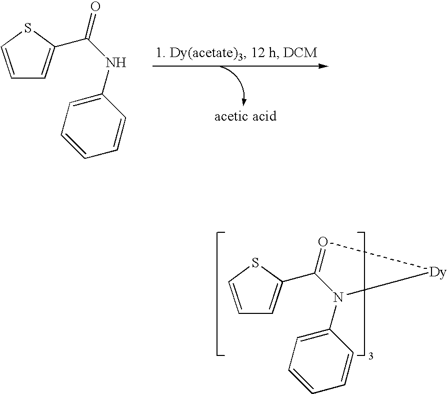

In 25 ml of anhydrous dichloromethane, 1.02 g of anhydrous dysprosium acetate was reacted with 1.83 g of the thiophene-2-carboxylic acid phenylamide of Example 1 for 12 h while stirring at room temperature. The solvent was then reduced to dryness under vacuo and the white solid was washed with anhydrous hexane. The product was obtained in 81% yield. (1.87 g mw 769.23 g/mol).

Elemental Analysis [DyC₃₃H₂₄N₃O₃S₃]: calculated. (found) H, 3.14; (3.32), C, 51.52; (50.34), N, 5.46; (5.34).

Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

### Example 13

### Thermal Stability

The thermal stability data as listed for the examples is shown in Table 2. Comparative compositions and data are labeled as compositions purchased from Gelest, Inc. Thermal stability was determined by heating the samples in capillary tubes in a range between 25° C. and 350° C. using a Melt Temp II melting point apparatus from Lab Devices USA. Photoluminescence was assessed visually at 10° C. increments until decomposition or extinction of the emitted photoluminescence signal upon excitation of the lanthanide amidate complex with an ultra-violet lamp (Entela model UVL-56; 6 W, 365 nm wavelength).

TABLE 2

| | Decomposition Temperature |
|---|---|
| | (Photoluminescence extinction |
| Lanthanide amidate complex | temperature in ° C.) |
| Example 1 | 300 |
| Example 2 | 350 |
| Example 3 | 230 |
| Example 4 | 250 |
| Example 5 | 240 |
| Example 6 | 350 |
| Example 7 | 350 |
| Example 8 | 340 |
| Example 9 | 230 |
| Example 10 | 230 |
| Example 11 | 220 |
| Eu(III) 1,3-diphenyl-1,3-propanedionate | No visible emission after 50 C. |
| (Gelest) | |
| Eu(III) thenoyltrifluoroacetate | No visible emission at room |
| (Gelest) | temperature |

What is claimed is:

1. A composition comprising a lanthanide chelate comprising a lanthanide and a ligand, the ligand represented by the formula 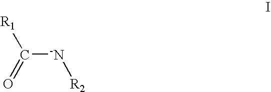
wherein R1 is alkyl, aryl, or heteroaryl; R₂ is alkyl, aminoalkyl, aryl or heteroaryl, with the proviso that R₁ and R₂ cannot both be phenyl, and with the proviso that R₂ cannot be phenyl when R₁ is alkyl.

2. The composition of claim 1 wherein the lanthanide is selected from Eu³⁺, Dy³⁺, Tb³⁺, and Sm³⁺.

3. The composition of claim 1 wherein the lanthanide is Eu³⁺

4. The composition of claim 1 wherein R₁ and R₂ are each independently selected from the group consisting of thiophenyl, pyridinyl, furanyl, phenyl, napthyl, anthracyl, phenanthrenyl, and dialkylaminoethyl with the proviso that R₁ and R₂ cannot both be phenyl.

5. The composition of claim 4 wherein R₂ is dimethylaminoethyl.

6. The composition of claim 1 further comprising a neutrally charged coordinating ligand.

7. The composition of claim 6 wherein the neutrally charged coordinating ligand is selected from the group consisting of pyridine, pyridine-N-oxide, thiophene, furane, ketones, 1,10-phenathroline, aryl, C1-C6 alkyl di-substituted ethylene bridged di-phosphine oxides, and C1-C6 alkyl-tri-substituted phosphine oxides.

8. A process comprising combining in a solvent a saturated aliphatic lanthanide carboxylate or fluorocarboxylate having 1 to 8 carbons, and a compound represented by the formula 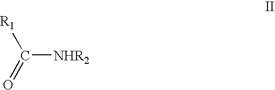
wherein R₁ is alkyl, aryl, or heteroaryl; and R₂ is alkyl, aminoalkyl; aryl or heteroaryl; with the proviso that R₁ and R₂ cannot both be phenyl and with the further proviso that R₂ cannot be phenyl when R₁ is alkyl.

9. The process of claim 8 wherein the lanthanide carboxylate or fluorocarboxylate is a lanthanide fluorocarboxylate.

10. The process of claim 9 wherein the lanthanide fluorocarboxylate is selected from the group consisting of Eu(CF₃COO)₃, Dy(CF₃COO)₃, Sm(CF₃COO)₃ and Tb(CF₃COO)₃.

11. The process of claim 10 wherein the lanthanide fluorocarboxylate is Eu(CF₃COO)₃.

12. The process of claim 8 wherein the solvent is selected from the group consisting of linear alkanes, cyclic alkanes, and aryl hydrocarbons, both halogenated and non-halogenated.

13. The process of claim 8 wherein the solvent is dichloromethane.

14. The process of claim 8 further comprising addition of a neutral coordination ligand to a solution of the lanthanide amidate product.

15. The process of claim 14 wherein the neutral coordination ligand is selected from the group consisting of pyridine, pyridine-N-oxide, thiophene, furane, ketones, 1,10-phenathroline, aryl, C1-C6 alkyl di-substituted ethylene bridged di-phosphine oxides, and C1-C6 alkyl-tri-substituted phosphine oxides.
